(19) United States
(12) Patent Application Publication
(10) Pub. No.: US 2012/0069129 A1
(43) Pub. Date: Mar. 22, 2012

(54) IMAGE FORMING APPARATUS AND IMAGE FORMING METHOD

(75) Inventor: Takahiro HAMANAKA, Shizuoka (JP)

(73) Assignees: Toshiba Tec Kabushiki Kaisha, Tokyo (JP); Kabushiki Kaisha Toshiba, Tokyo (JP)

(21) Appl. No.: 13/208,187

(22) Filed: Aug. 11, 2011

Related U.S. Application Data
(60) Provisional application No. 61/384,678, filed on Sep. 20, 2010.

(51) Int. Cl. B41J 2/435

(52) U.S. Cl. 347/237

(57) ABSTRACT

An image forming apparatus includes a laser exposure device including plural laser oscillators, at least two pattern detection sensors to detect a pattern of forced light emission lines formed on a transfer belt by forced light emission of the plural laser oscillators at a time of initialization of the laser exposure device, and a shift amount calculation part to calculate a position shift amount between the forced light emission lines from output signals of the pattern detection sensors.

### CROSS-REFERENCE TO RELATED APPLICATION

This application is based upon and claims the benefit of priority from Provisional U.S. Application 61/384,678 filed on Sep. 20, 2010, the entire contents of which are incorporated herein by reference.

### FIELD

Embodiments described herein relate generally to an image forming apparatus and an image forming method.

### BACKGROUND

Hitherto, there is a function in which wedge-shaped registration patterns each including a straight line and an oblique line are printed on a transfer belt, and a registration sensor detects the registration patterns of respective colors of Y (Yellow), M (Magenta), C (Cyan) and K (black), so that various color shifts, such as an image inclination shift, a sub-scanning position shift, a main scanning position shift and a main scanning magnification shift, are corrected. This correction function is called registration.

However, since the print operation of the registration is required to be performed independently of a normal print operation, the registration is required to be performed at a timing when the normal print operation is not performed (for example, at a warming-up time, before the print operation, after the print operation, etc.).

Accordingly, there is a problem that awaiting time required before start of printing becomes long by the execution time of the registration.

According to one embodiment, an image forming apparatus and an image forming method are provided in which color shift correction can be performed in a short time by using forced light emission lines of respective colors printed on a transfer belt at the time of forced light emission performed when a laser exposure device is initialized.

### BRIEF DESCRIPTION OF THE DRAWINGS

FIG. 1 is a view showing an example of an image forming apparatus of a first embodiment.

FIG. 2 is an explanatory view of laser exposure in the embodiment.

FIG. 3 is a block structural view of a control system of the image forming apparatus in the embodiment.

FIG. 4 is a block structural view of a color shift correction process in a system control part of the embodiment.

FIG. 5 is a flowchart of forced light emission performed in an initialization operation of a laser exposure device of the embodiment.

FIG. 6 is an explanatory view of the initialization operation of the laser exposure device of the embodiment.

FIG. 7 is a view for explaining a transfer operation of forced light emission lines formed on a transfer belt in the embodiment.

FIG. 8 is a view showing a relation between the forced light emission lines on the transfer belt and pattern detection sensors in the embodiment.

FIG. 9 is a flowchart showing a color shift correction process in the embodiment.

FIG. 10 is a view showing inclination shift correction amounts of the forced light emission lines in the embodiment.

FIG. 11 is a view showing sub-scanning position shift correction amounts of the forced light emission lines in the embodiment.

FIG. 12 is a view for explaining time shortening of a print operation in the embodiment.

FIG. 13 is a block structural view of a color shift correction in a system control part of a second embodiment.

FIG. 14 is a flowchart showing registration execution based on shift amounts in the embodiment.

FIG. 15 is a view for explaining time shortening of a print operation in the embodiment.

### DETAILED DESCRIPTION

In general, according to one embodiment, an image forming apparatus includes a laser exposure device including plural laser oscillators, at least two pattern detection sensors to detect a pattern of forced light emission lines formed on a transfer belt by forced light emission of the plural laser oscillators at a time of initialization of the laser exposure device, and a shift amount calculation part to calculate a position shift amount between the forced light emission lines from output signals of the pattern detection sensors.

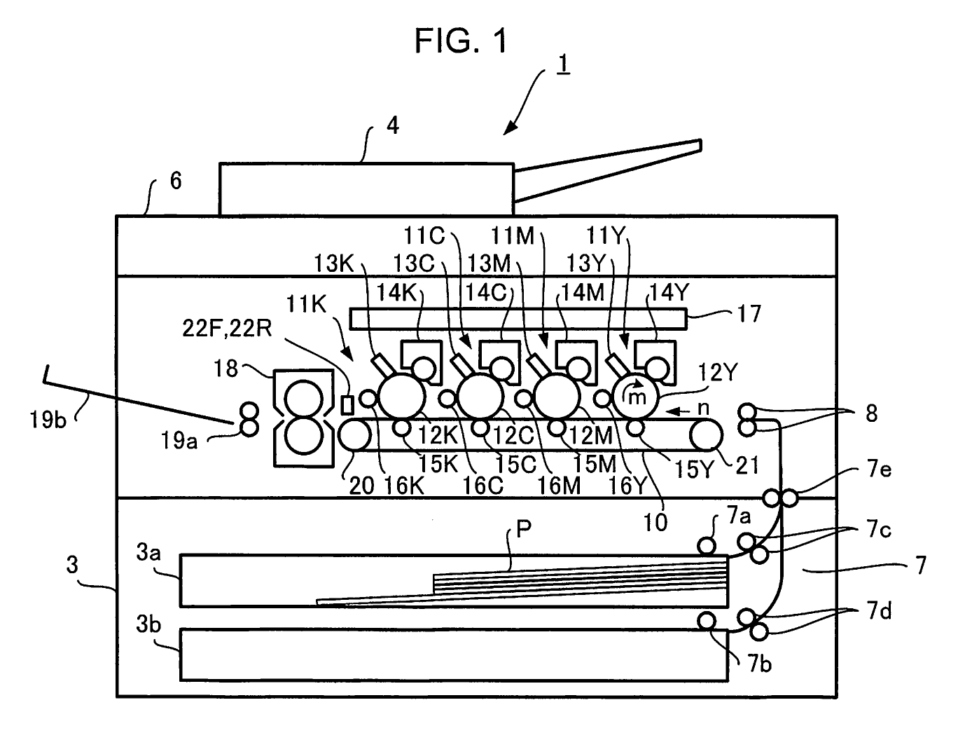

Hereinafter, embodiments will be described in detail with reference to FIG. 1 to FIG. 15. An image forming apparatus of an exemplary embodiment includes, for example, a color copy machine to perform color and monochrome printing at a high resolution, and a multi-function peripheral (MFP) capable of performing various processes, such as a function to copy a document, a function to communicate with an external equipment, and a function to transmit and receive and to print as a facsimile apparatus.

### First Embodiment

FIG. 1 shows an example of an image forming apparatus. In this embodiment, the image forming apparatus can perform color copying, development and printing. Incidentally, although the image forming apparatus shown in FIG. 1 is a four-drum tandem color copy machine of a direct transfer system, the embodiment can be similarly applied also to an apparatus of an indirect transfer system.

The image forming apparatus 1 includes an auto document feeder 4 and a scanner part 6 to read a document fed by the auto document feeder 4. The image forming apparatus 1 includes four sets of image forming parts 11Y, 11M, 11C and 11K of yellow (Y), magenta (M), cyan (C) and black K) arranged in parallel along a transfer belt 10 as a running member.

The respective image forming parts 11Y, 11M, 11C and 11K include photoconductive drums 12Y, 12M, 12C and 12K. The rotation axes of the photoconductive drums 12Y, 12M, 12C and 12K are parallel to a direction (main scanning direction) perpendicular to a running direction (sub-scanning direction) of an arrow n direction of the transfer belt 10. Further, the respective rotation axes of the photoconductive drums 12Y, 12M, 12C and 12K are arranged at equal intervals along the sub-scanning direction. The respective photoconductive drums 12Y, 12M, 12C and 12K rotate in an arrow m direction in a print operation.

Charging charger 13Y, 13M, 13C and 13K, developing devices 14Y, 14M, 14C and 14K, and photoreceptor cleaners 16Y, 16M, 16C and 16K are arranged around the photoconductive drums 12Y, 12M, 12C and 12K along the rotation direction of the arrow m direction. The developing devices 14Y, 14M, 14C and 14K respectively include developers including toners of yellow (Y), magenta (M), cyan (C) and black (K) and carriers, and supply the toners to electrostatic latent images on the photoconductive drums 12Y, 12M, 12C and 12K.

Laser beams for exposure by a laser exposure device 17 are irradiated to the photoconductive drums 12Y, 12M, 12C and 12K between the charging chargers 13Y, 13M, 13C and 13K and the developing devices 14Y, 14M, 14C and 14K, and electrostatic latent images L are formed on the photoconductive drums 12Y, 12M, 12C and 12K.

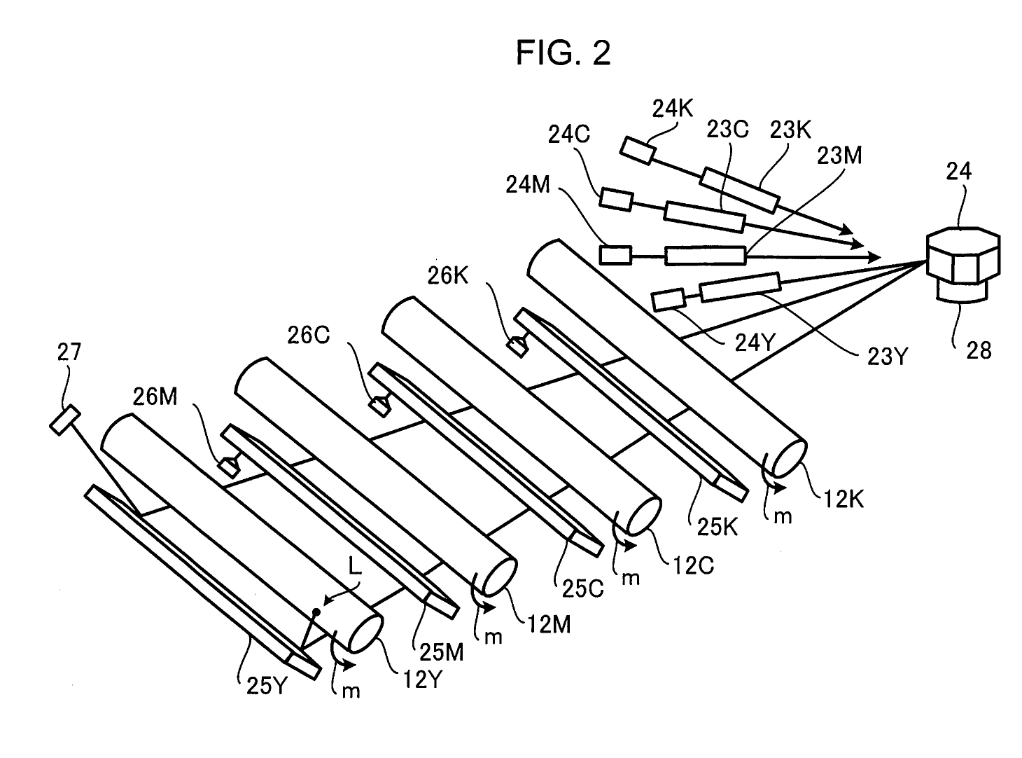

As shown in FIG. 2, the laser exposure device 17 includes laser oscillators 23Y, 23M, 23C and 23K to output the laser beams for exposing the photoconductive drums 12Y, 12M, 12C and 12K. The laser oscillators 23Y, 23M, 23C and 23K are controlled by laser drivers 24Y, 24M, 24C and 24K based on data of respective color components of image data read by the scanner part 6.

The laser beams outputted from the laser oscillators 23Y, 23M, 23C and 23K are scanned in the main scanning direction by a polygon mirror 24. Incident angles of the laser beams to the photoconductive drums 12Y, 12M, 12C and 12K are determined by tilt mirrors 25Y, 25M, 25C and 25K. Thus, the tilt mirrors 25Y, 25M, 25C and 25K are adjusted so that the rotation axes of the photoconductive drums 12Y, 12M, 12C and 12K are parallel to the scanning directions of the laser beams. Further, since the tilt mirrors 25M, 25C and 25K are adjusted with reference to the tilt mirror 25Y of yellow (Y), the inclined angles of the tilt mirrors 25M, 25C and 25K can be adjusted by tilt motors 26M, 26C and 26K.

A horizontal synchronization signal detection sensor 27 is provided on an extension of the photoconductive drum 12Y in the main scanning direction. The horizontal synchronization detection sensor 27 detects the scan start of the laser beam of the laser oscillator 23Y in the main scanning direction among the laser beams outputted from the laser oscillators 23Y, 23M, 23C and 23K, and outputs a horizontal synchronization signal. The polygon mirror 24 is rotated by a polygon mirror motor 28. In the case of this embodiment, since only one horizontal synchronization detection sensor 27 exists, after the horizontal synchronization of the laser beam from the laser oscillator 23Y is achieved, the horizontal synchronization of the laser beams outputted from the remaining laser oscillators 23M, 23C and 23K for magenta (M), cyan (C) and black (K) can be achieved by shifting the laser beams from the laser beam of the laser oscillator 23Y by specified intervals.

Besides, differently from this embodiment, when the horizontal synchronization signal detection sensors 27 are arranged also for the remaining magenta (M), cyan (C) and black (K), the horizontal synchronization signal detection sensors may detect the laser beams of the laser oscillators 23Y, 23M, 23C and 23K of the respective colors.

The transfer belt 10 is supported by a belt drive roller 20 and a driven roller 21, and the transfer belt 10 is moved and rotated in an arrow n direction by a belt drive motor (not shown) to drive the belt drive roller 20. Color toner images formed on the photoconductive drums 12Y, 12M, 12C and 12K are transferred to a conveyed sheet P by the transfer belt 10 at positions of transfer rollers 15Y, 15M, 15C and 15K.

The sheet P is fed to the transfer belt 10 through a conveyance path 7 from a cassette mechanism 3 including a first and a second paper feed cassettes 3a and 3b. The conveyance path 7 includes pickup rollers 7a and 7b to take out the sheet P from the paper feed cassettes 3a and 3b, separation conveyance roller 7c and 7d, a conveyance roller 7e and a register roller 8.

The color toner images formed on the sheet P by the image forming parts 11Y, 11M, 11C and 11K are fixed by a fixing device 18, and the sheet is discharged to a paper discharge tray 19b through a paper discharge roller 19a.

After the color toner images are transferred to the sheet P, residual toners on the photoconductive drums 12Y, 12M, 12C and 12K are cleaned by the photoreceptor cleaners 16Y, 16M, 16C and 16K, and preparation for a next print operation is ended.

At the downstream side of the image forming part 11K and above the transfer belt 10, a pair of a pattern detection sensor 22F and a pattern detection sensor 22R are arranged at the front side and the rear side of the image forming apparatus 1. These sensors are arranged to be spaced from each other by a specified distance in the main scanning direction. The position relation of the pattern detection sensor 22F and the pattern detection sensor 22R is made such that both ends of a forced light emission line described later can be detected.

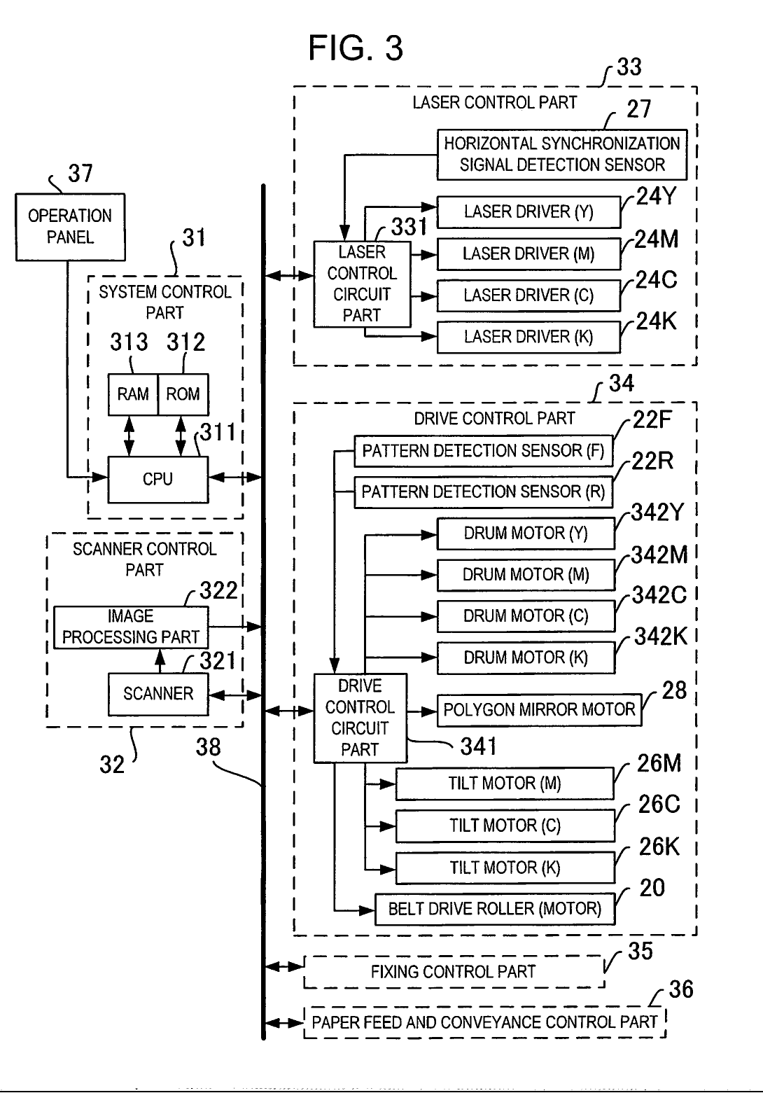

FIG. 3 is block structural view of a control system of the image forming apparatus 1. The control system includes a system control part 31 to integrally control the image forming apparatus 1, a scanner control part 32 to control document reading and then to perform an image processing, a laser control part 33 to expose based on image data subjected to the image processing, a mechanism control part 34 to control a printer mechanism, a fixing control part 35 to fix a toner image after exposure to a sheet, a paper feed and conveyance part 36 to feed and convey a document or a sheet, and an operation panel 37 by which a user performs various setting operations such as print instruction and print condition.

The system control part 31 includes a CPU (Central Processing Unit) 311 to integrally control the image forming apparatus 1, a ROM (Read Only Memory) 312 to store programs (firmware) necessary for control and various setting parameters, and a RAM (Random Access Memory) 313 to temporarily store computation results and the like. The system control part 31 integrally controls the control parts so that the color shift correction of the embodiment is performed.

The scanner control part 32 controls the scanner part 6 of FIG. 1, and includes a scanner 321 to read a document supplied by the auto document feeder 4 by line sensors of R (Red), G (Green), B (Blue) and monochrome (black), and an image processing part 322 to digitally process the image data read by the scanner 321.

The laser control part 33 includes a laser control circuit part 331 to perform exposure control based on the image data processed by the image processing part 322, and controls the horizontal signal detection sensor 27 and the laser drivers 24Y, 24M, 24C and 24K.

The drive control part 34 includes a drive control circuit part 341 to drive mechanisms necessary for the print operation, and controls the pattern detection sensors 22F and 22R, drum motors 342Y, 342M, 342C and 342K, the polygon mirror motor 28, the tilt mirror motors 26M, 26C and 26K, and the belt drive roller (motor) 20.

The fixing control part 35 controls the fixing device 18. The paper feed and conveyance part 36 controls the auto document feeder 4, the cassette mechanism 3, the conveyance path 7, the paper discharge roller 19 and the like.

The system control part 31, the scanner control part 32, the laser control part 33, the drive control part 34, the fixing control part 35 and the paper feed and conveyance control part 36 are connected to an inner input and output interface 38 controlled by the CPU 311.

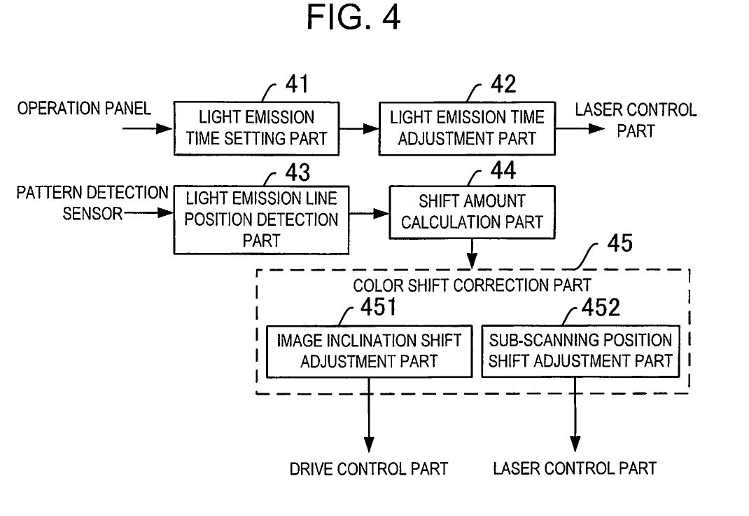

FIG. 4 is a block structural view of a color shift correction process performed in the system control part 31. The color shift correction process of this embodiment includes a light emission time setting part 41 to set and store, in units of scan lines, a time of forced light emission performed at the time of an initialization operation of the laser exposure device 17, which is always performed before the print operation or before registration execution, a light emission time adjustment part 42 to adjust the forced light emission times of the laser oscillators 23Y, 23M, 23C and 23K based on the light emission time setting, a light emission line position detection part 43 to detect positions of four forced light emission lines formed on the transfer belt 10 by the forced light emission, a shift amount calculation part 44 to calculate a shift amount from positional shift between the forced light emission lines, and a color shift correction part 45 to perform a color shift correction from the shift amount obtained by the shift amount calculation part 44.

The color shift correction part 45 includes an image inclination shift adjustment part 451 to correct an image inclination, and a sub-scanning position shift adjustment part 452 to correct a position shift in the sub-scanning direction.

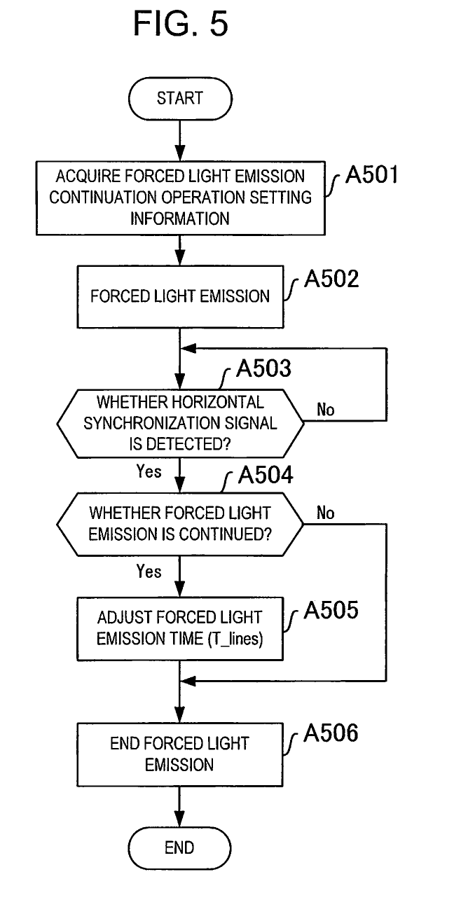

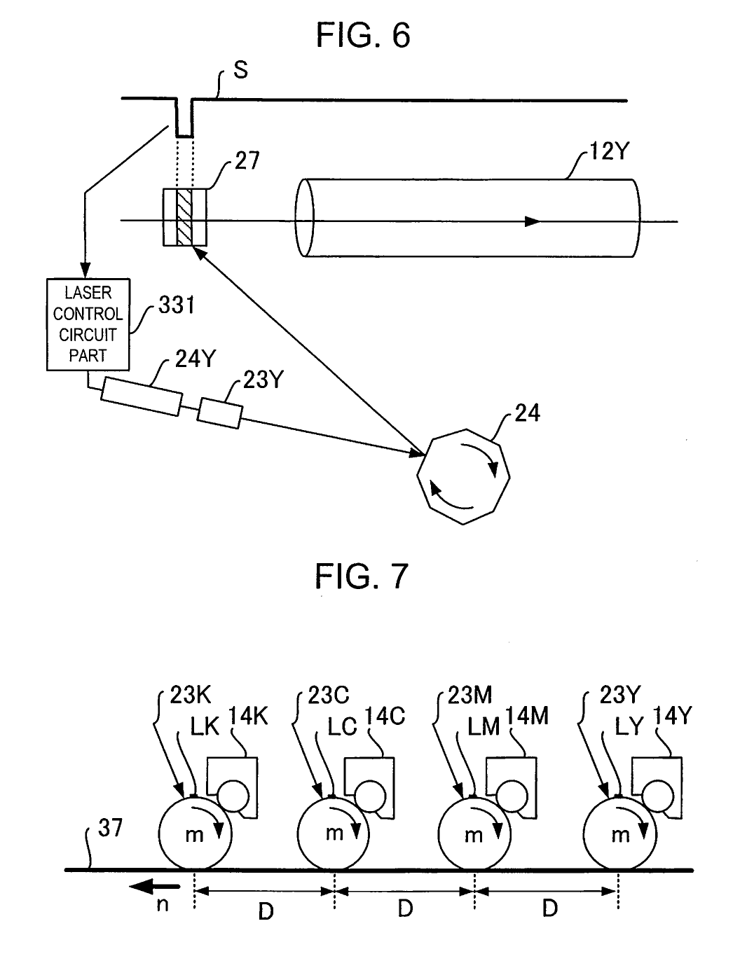

FIG. 5 shows a flowchart of the forced light emission performed at the time of the initialization operation of the laser exposure device 17. First, the initialization operation of the laser exposure device 17 will be described with reference to FIG. 6. The initialization operation is the operation of performing horizontal synchronization in order to determine the scan origin in the main scanning direction by causing the four laser oscillators 23Y, 23M, 23C and 23K to simultaneously and forcibly emit light in the state where the polygon mirror 24 rotates. In FIG. 6, a description will be made on an example in which with respect to the laser oscillator 23Y of the reference color (yellow), the horizontal synchronization is performed by scanning the drum 12Y of the reference color.

First, based on the control signal of the laser control circuit part 331, the laser oscillator 23Y scans the horizontal synchronization signal detection sensor 27 and the reference color drum 12Y through the polygon mirror 24. Here, it is assumed that the horizontal synchronization signal detection sensor 27 is mounted only on the reference color drum 12Y. When the horizontal synchronization signal detection sensor 27 detects the laser beam of the laser oscillator 23Y, a laser beam detection signal S is inputted to the laser control circuit part 331, and the print origin of the laser beam in the main scanning direction can be detected. When the laser control circuit part 331 detects the horizontal synchronization signal, the forced light emission operation of the four laser oscillators 23Y, 23M, 23C and 23K is ended. In order to assure the accuracy of the horizontal synchronization, the forced light emission operation is continuously performed for several lines.

Next, forced light emission lines formed on the transfer belt 10 by the forced light emission operation will be described with reference to FIG. 7. Forced light emission lines LY, LM, LC and LK as electrostatic latent images are printed on the photoconductive drums 12Y, 12M, 12C and 12K by the forced light emission operation of the laser oscillators 23Y, 23M, 23C and 23K. The forced light emission lines LY, LM, LC and LK move in an arrow m direction on the photoconductive drums, and are respectively developed by the developing devices 14Y, 14M, 14C and 14K. The forced light emission lines LY, LM, LC and LK are printed on the transfer belt 10 at intervals of a drum interval D. When the forced light emission is ended, the initialization of the laser exposure device 17 is completed and the print operation becomes possible.

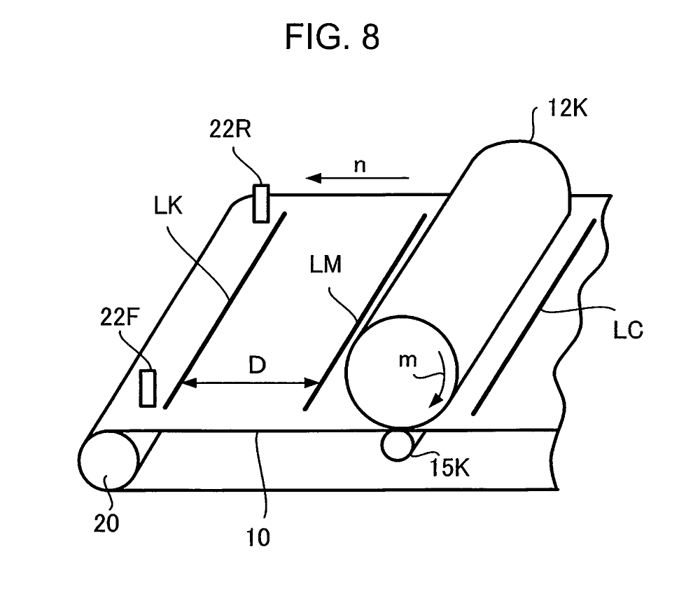

As shown in FIG. 8, the forced light emission lines LY, LM, LC and LK (LY is not shown) sequentially move in an arrow n direction on the transfer belt 10, and the pattern detection sensors 22F and 22R detect the passing time.

In this embodiment, registration sensors to detect registration patterns can be used also as the pattern detection sensors 22F and 22R. However, in general, since the forced light emission line of each color formed by the forced light emission is as thin as several lines necessary for the horizontal synchronization, there is a possibility that the normal registration sensor can not recognize the thin forced light emission line.

Accordingly, light emission is continuously performed also after the completion of the horizontal synchronization, and the width of the forced light emission line is increased so that the pattern detection sensors 22F and 22R can identify the line. The setting as to whether the forced light emission time is continued or not is specified by the user through the operation panel 37 or is automatically set by the image forming apparatus 1. Besides, the continuation time of the forced light emission time is set in units of time of scanning one line.

At Act A501 of FIG. 5, continuation setting of the forced light emission performed in the initialization of the laser exposure device 17 is specified through the operation panel 37, or the continuous setting information automatically set in the image forming apparatus 1 in advance is acquired. The continuous setting information of the forced light emission is stored in the light emission time setting part 41.

At Act A502, in order to start the initialization of the laser exposure device 17, the laser control circuit part 331 drives the laser drivers 24Y, 24M, 24C and 24K, and performs the forced light emission of the laser oscillators 23Y, 23M, 23C and 23K.

At Act A503, a determination is made as to whether the horizontal synchronization detection sensor 27 detects the horizontal synchronization signal. When the horizontal synchronization signal is detected (Act A503: Yes), advance is made to next Act A504. When the horizontal synchronization signal is not detected (Act A503: No), the laser oscillator 23Y continues the forced light emission until the horizontal synchronization is achieved, and the photoconductive drum 12Y is repeatedly scanned.

At Act A504, based on the continuous setting information of the light emission time setting part 41, a determination is made as to whether the forced light emission is continued. When the forced light emission is continued (Act A504: Yes), advance is made to next Act 505. When the forced light emission is not continued (Act A504: No), advance is made to Act A506, and the forced light emission of the laser oscillators 23Y, 23M, 23C and 23K is ended.

At Act A505, based on the continuous setting information acquired at Act A501, the forced light emission continuation time is adjusted, and the laser oscillators 23Y, 23M, 23C and 23K continue the forced light emission. The forced light emission continuation time is the time in which the line width (line number T lines) becomes such that the pattern detection sensors 22F and 22R can identify the forced light emission lines LY, LM, LC and LK. The forced light emission continuation is performed by the instruction of the light emission time adjustment part 42.

Incidentally, in the embodiment, the flowchart is for enabling the pattern detection sensors 22F and 22R to be used also as the registration sensors. Accordingly, when the pattern detection sensors 22F and 22R capable of identifying the thin light emission pattern formed in the horizontal synchronization are provided separately from the registration sensors, Act A504 and Act A505 are unnecessary.

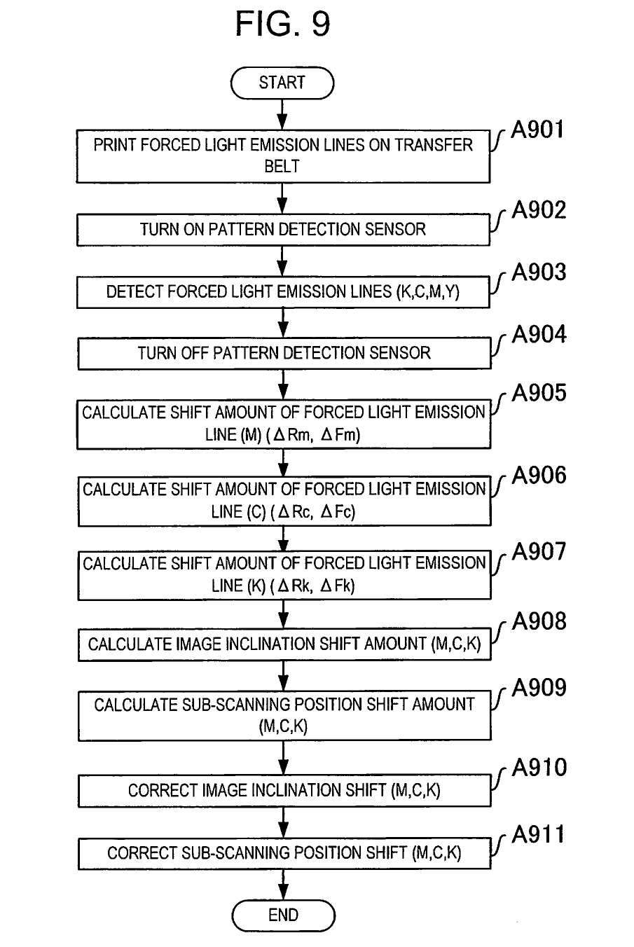

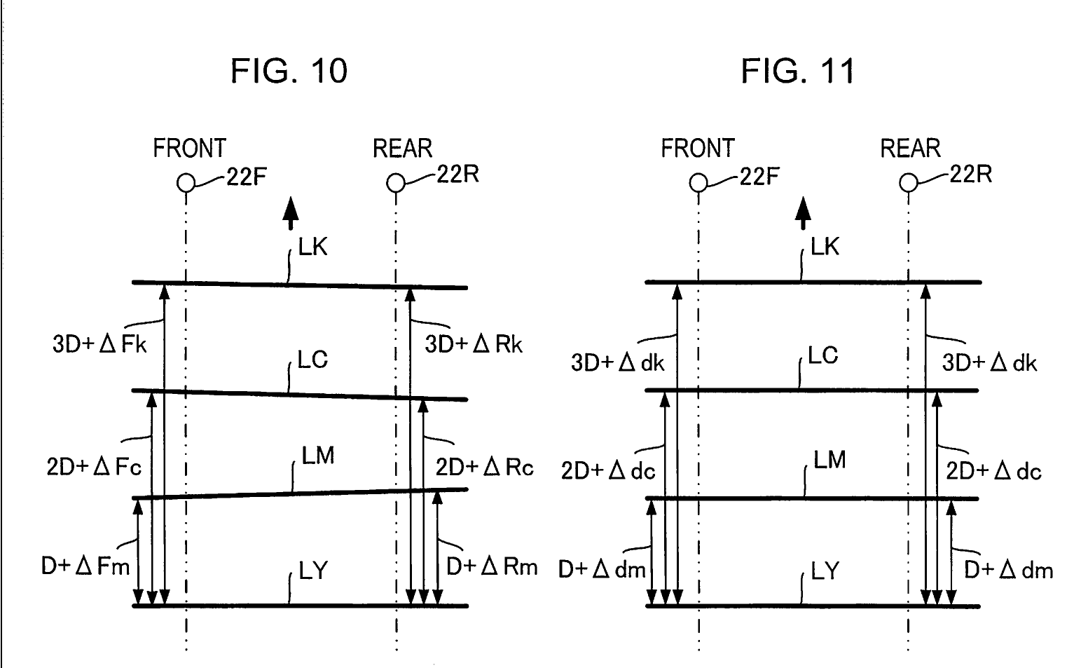

Next, an image inclination shift correction performed in the color shift correction of the embodiment and a position shift correction in the sub-scanning direction will be described with reference to FIG. 9, FIG. 10 and FIG. 11.

At Act A901, the forced light emission lines LY, LM, LC and LK explained in the flowchart of FIG. 5 are printed on the transfer belt 10. At Act A902, the pattern detection sensors 22F and 22R are turned ON. As the transfer belt 10 moves, the forced light emission lines LK, LC, LM and LY sequentially pass under the pattern detection sensors 22F and 22R.

At Act A903, the forced light emission lines LK, LM, LC and LY are detected. The emission line position detection part 43 actuates a timer, and detects the time when the forced light emission lines LK, LC, LM and LY pass under the pattern detection sensors 22F and 22R.

Each of the pattern detection sensors 22F and 22R includes a light-emitting part such as an LED and a light detector, and a light emitted from the light-emitting part illuminates a specified position of the transfer belt 10. The light detector detects the amount of reflected light from the illuminated transfer belt 10, and sequentially detects the forced light emission lines LK, LM, LC and LY. The interval between the pattern detection sensors 22F and 22R is such that both end portions of each of the forced light emission lines LK, LM, LC and LY are detected, and the sensors are arranged in parallel to the rotation axis of the photoconductive drum 12Y.

At Act A904, after the pattern detection sensors 22F and 22R detect the positions of the respective forced light emission lines LK, LM, LC and LY, the pattern detection sensors are once turned OFF.

Next, at Act A905, a shift amount between the forced light emission lines detected by the pattern detection sensors 22F and 22R is calculated. FIG. 10 shows the shift amount between the forced light emission lines detected by the pattern detection sensors 22F and 22R. The pattern detection sensors 22F and 22R detect the forced light emission lines LK, LC, LM and LY on the transfer belt 10. The forced light emission line LY (yellow) is used as a basis, and a distance from the forced light emission line LY is calculated from the time measured by the timer and the speed of the transfer belt. At this time, the photoconductive drums 12Y, 12M, 12C and 12K are assumed to be arranged at equal intervals, and the interval is D.

Accordingly, in the example of FIG. 10, the interval between the forced light emission line LM and the forced light emission line LY is detected to be (D+ΔFm) at the pattern detection sensor 22F side and (D+ΔRm) at the pattern detection sensor 22R side.

At Act A906, the interval between the forced light emission line LC and the forced light emission line LY is detected to be (2D+ΔFc) at the pattern detection sensor 22F side and (2D+ΔRc) at the pattern detection sensor 22R side.

At Act A907, the interval between the forced light emission line LK and the forced light emission line LY is detected to be (3D+ΔFk) at the pattern detection sensor 22F side and (3D+ΔRk) at the pattern detection sensor 22R side.

Since the shift amounts ΔFm, ΔRm, ΔFc, ΔRc, ΔFk and ΔRk include two factors of the image inclination shift and the sub-scanning position shift, the image inclination shift amount is first calculated as described below.

At act A908, the magenta image inclination shift amount is calculated from the forced light emission line LM by expression (1).

(magenta image inclination shift amount)=|(D+ΔRm)−(D+ΔFm)|=|ΔRm−ΔFm| (1)

The magenta image inclination shift is corrected by correcting so that the shift amount calculated by the expression (1) becomes 0.

Similarly, the cyan image inclination shift amount is calculated from the forced light emission line LC by expression (2).

(cyan color image inclination shift amount)=|(2D+ΔRc)−(2D+ΔFc)|=|ΔRc−ΔFc| (2)

The cyan image inclination shift is corrected by correcting so that the shift amount calculated by the expression (2) becomes 0.

Further, the black image inclination shift amount is calculated from the forced light emission line LK by expression (3).

(black color image inclination shift amount)=|(3D+ΔRk)−(3D+ΔFk)|=|ΔRk−ΔFk (3)

The black image inclination shift is corrected by correcting so that the shift amount calculated by the expression (3) becomes 0.

Besides, at Act A909, as shown in FIG. 11, although the forced light emission lines LK, LC, LM and LY after the image inclination shift correction become parallel to each other, the intervals are not always equal to each other. Accordingly, for example, when the interval between the forced light emission line LY and the forced light emission line LM after the image inclination correction is (D+Δdm), the interval between the forced light emission line LY and the forced light emission line LC is (2D+Δdc), and the interval between the forced light emission line LY and the forced light emission line LK is (3D+Δdc), Δdm, Δdc and Δdk are calculated to be the position shift amounts in the sub-scanning direction. The sub-scanning position shift is corrected by correcting so that the sub-scanning position shift amounts Δdm, Δdc and Δdk become 0.

At Act A910, correction is performed so that the image inclination shift amounts obtained from the expression (1) to the expression (3) become 0. In the image inclination shift correction, the tilt mirror motors are driven in the image inclination shift adjustment part 451, and the angles of the tilt mirrors are adjusted, so that the image inclination is corrected.

At Act A911, correction is performed so that the sub-scanning position shifts Δdm, Δdc and Δdk become 0. In the sub-scanning position shift correction, the laser scanning timing of the laser control circuit part 331 is adjusted in the sub-scanning position shift adjustment part 452, so that the position shift in the sub-scanning direction is corrected.

By adopting the structure as stated above, the image inclination shift and the sub-scanning direction position shift can be corrected by using the forced light emission lines printed by the forced light emission operation at the time of start of printing.

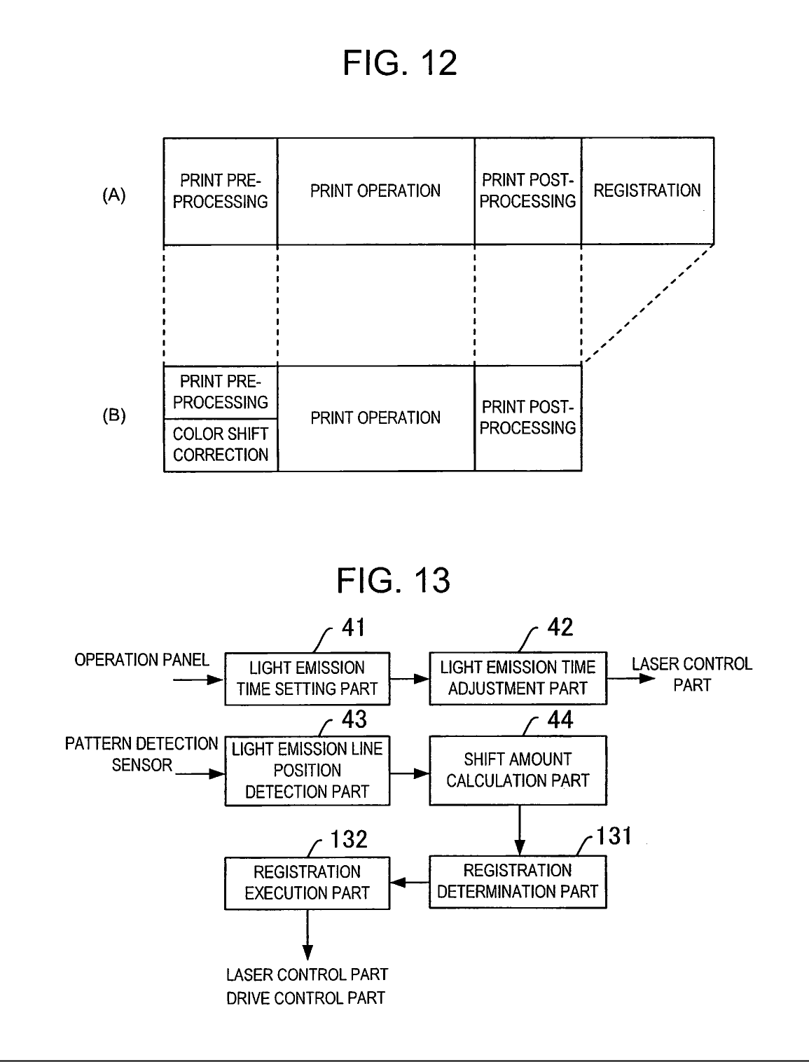

The effect of time shortening of the embodiment will be described with reference to FIG. 12. FIG. 12, (A) shows an example of the related art, and FIG. 12, (B) shows an example of this embodiment. The registration is performed at the time of warming-up, before printing, or after printing. FIG. 12, (A) shows the example in which the registration is performed after printing. However, in this embodiment, since the color shift correction can be performed simultaneously with print pre-processing, the registration after print post-processing becomes unnecessary. Since the registration takes normally 30 seconds to 40 seconds, the waiting time for the user is greatly reduced.

In this embodiment, the image inclination shift and the sub-scanning position shift are performed among the image inclination shift, the sub-scanning position shift, the main scanning position shift and the main scanning magnification shift performed in the registration, and are always performed when the laser exposure device 17 is initialized before the print operation. Thus, since the color shift correction is always performed, the number of times of the registration can be greatly reduced. The execution timing of the registration will be described later in a second embodiment. Further, since the image inclination shift and the sub-scanning position shift are corrected in this embodiment, only the main scanning position shift and the main scanning magnification shift may be performed at the time of execution of the registration. In this case, the execution time of the registration can be shortened.

As described above, according to the first embodiment, the number of times of the registration, which is performed at the time of warming-up, before the print operation, after the print operation and the like, can be greatly reduced, and the time required for the registration can be reduced. Besides, the forced light emission line formed when the laser exposure device 17 is initialized is used, and the registration sensor can be used also as the pattern detection sensor to detect the forced light emission line. Thus, this embodiment can be realized by only addition of the firmware without newly adding hardware. Accordingly, the print performance can be improved at low cost.

### Second Embodiment

In this embodiment, an image forming apparatus capable of determining the execution timing of registration will be described.

FIG. 13 is a block structural view of a color shift correction process performed in the system control part 31. There are provided a light emission time setting part 41 to set and store, in units of scan lines, a time of forced light emission performed at the time of an initialization operation of the laser exposure device 17, a light emission time adjustment part 42 to adjust the forced light emission times of the laser oscillators 23Y, 23M, 23C and 23K based on the light emission time setting, a light emission line position detection part 43 to detect positions of four forced light emission lines formed on the transfer belt 10 by the forced light emission, a shift amount calculation part 44 to calculate a shift amount from a position shift between the forced light emission lines, a registration determination part 131 to determine execution of registration from the shift amount obtained by the shift amount calculation part 44, and a registration execution part 132 to execute the registration at a specified schedule based on a registration flag set by the registration determination part 131.

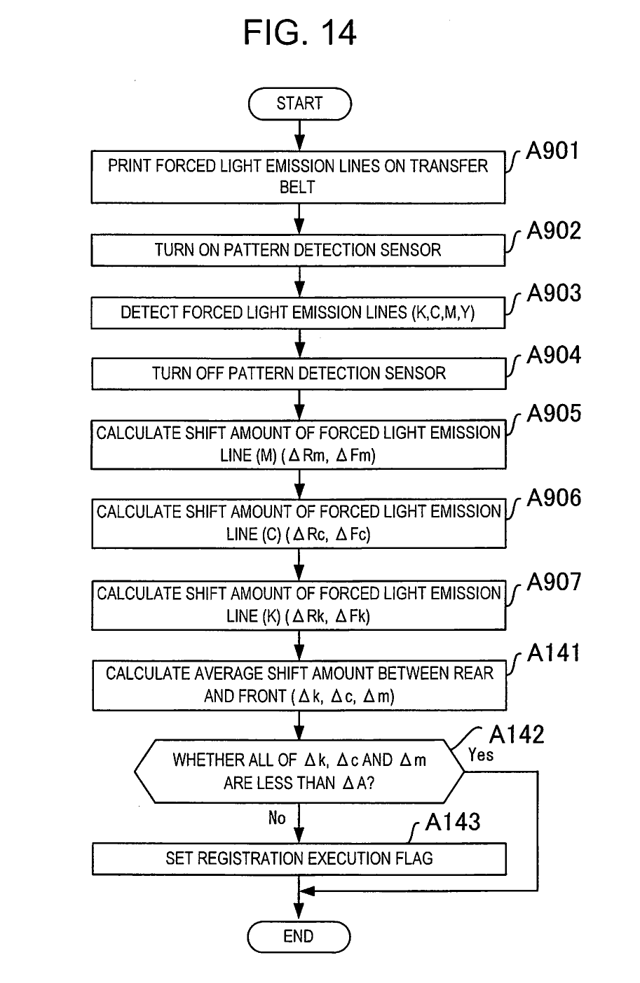

Next, a calculation method of a color shift correction amount and an execution timing of registration will be described with reference to FIG. 14. Since the procedure from Act A901 to Act A907 is the same as the flowchart of FIG. 9, the description thereof will be omitted.

At Act A141, an average shift amount between the rear and the front detected by the pattern detection sensors 22R and 22F is calculated. Specifically, with respect to the respective forced light emission lines LK, LC and LM, the arithmetic average of the shift amount at the front side detected by the pattern detection sensor 22F and the shift amount at the rear side detected by the pattern detection sensor 22R is obtained as in expressions (4), (5) and (6).

$$\begin{matrix}( shift amount of forced light emission line LK : Δ k ) = ( Δ Rk + Δ Fk ) / 2 & ( 4 ) \\ ( shift amount of forced light emission line LC : Δ c ) = ( Δ Rc + Δ Fc ) / 2 & ( 5 ) \\ ( shift amount of forced light emission line LM : Δ m ) = ( Δ Rm + Δ Fm ) / 2 & ( 6 )\end{matrix}$$

The calculation of the shift amounts is performed by the shift amount calculation part 44.

At Act A142, a determination is made as to whether all of Δk, Δc and Δm obtained by the shift amount calculation part 44 are less than an allowable value AA. When all of Δk, Δc and Δm are less than AA (Act A142: Yes), the procedure is ended. When one of Δk, Δc and Δm is the allowable value AA or more (Act A142: No), advance is made to Act A143.

At Act A143, a flag (registration execution flag) for executing the registration is set. The registration determination part 131 records the registration execution flag in the RAM 312. The registration execution part 132 causes the registration to be executed at an arbitrary timing (during standby, after the print operation, etc.). The firmware in which the registration execution schedule is described is stored in the ROM 313.

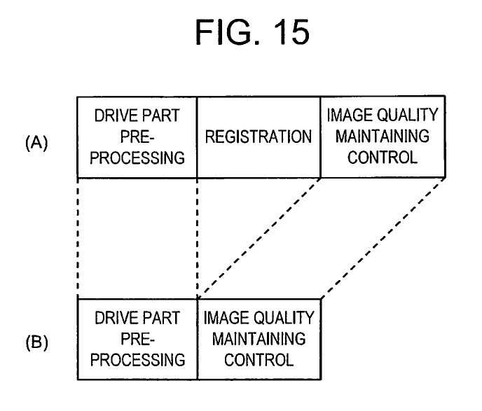

Finally, the effect of time shortening of the embodiment will be described with reference to FIG. 15. FIG. 15, (A) shows an example of warming-up of the related art, and FIG. 15, (B) shows an example of this embodiment. At the time of warming-up of the related art, the registration is performed after the pre-processing of the drive control part 34, and the image quality maintaining control or the like is performed after the execution of the registration. However, in this embodiment, when the shift amount is within the allowable value AA, the color shift is regarded as not occurring, and the registration can be omitted.

Accordingly, according to the second embodiment, in addition to the effect of the first embodiment, since the determination can be accurately made as to whether the registration is to be performed or not, the registration can be performed at the optimum timing.

Incidentally, in combination with the first embodiment, when the shift amount is within the specified allowable value ΔA, the color shift correction performed at the time of the forced light emission may not be performed.

As described above, according to the embodiment, since the image inclination shift and sub-scanning position shift can be corrected during the forced light emission operation of the laser exposure device performed at the time of start of printing or the like, the registration can be made not to be performed at a timing independent of the print operation, such as during warming up, during standby or after print operation. Accordingly, the embodiment can greatly contribute to the shortening of warming-up time, the elongation of lives of various image forming drive components, such as a drum and a transfer belt, and reduction in toner consumption amount. Besides, the determination can be made as to whether the registration is performed or not, and the registration execution timing can be optimized.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and sprit of the inventions.

What is claimed is:

1. An image forming apparatus comprising:
a laser exposure device including a plurality of laser oscillators;
at least two pattern detection sensors to detect a pattern of forced light emission lines formed on a transfer belt by forced light emission of the plurality of laser oscillators at a time of initialization of the laser exposure device; and
a shift amount calculation part to calculate a position shift amount between the forced light emission lines from output signals of the pattern detection sensors.

2. The apparatus of claim 1, further comprising:
an image inclination shift adjustment part to correct an image inclination shift based on the shift amount; and
a sub-scanning position shift adjustment part to adjust a position shift in a sub-scanning direction based on the shift amount.

3. The apparatus of claim 2, wherein the image inclination shift is corrected by adjusting an inclination of a tilt mirror.

4. The apparatus of claim 3, wherein the sub-scanning position shift is corrected by adjusting scanning timings of the plurality of laser oscillators.

5. The apparatus of claim 4, wherein registration sensors are used as the pattern detection sensors.

6. The apparatus of claim 1, further comprising:
a light emission time setting part to set and store light emission times of the plurality of laser oscillators to adjust line widths of the forced light emission lines; and
a light emission time adjustment part to adjust light emission times of the plurality of laser oscillators based on the light emission times.

7. The apparatus of claim 6, wherein the light emission times are times in which the line widths of the forced light emission lines become line widths which can be identified by the pattern detection sensors.

8. The apparatus of claim 7, further comprising an operation panel capable of switching and setting the light emission times.

9. An image forming apparatus comprising:
a laser exposure device including a plurality of laser oscillators;
at least two pattern detection sensors to detect a pattern of forced light emission lines formed on a transfer belt by forced light emission of the plurality of laser oscillators at a time of initialization of the laser exposure device;
a shift amount calculation part to calculate a shift amount between the forced light emission lines from output signals of the pattern detection sensors; and
a registration determination part to set a registration flag based on the shift amount.

10. The apparatus of claim 9, further comprising a registration execution part to execute registration based on the registration flag.

11. The apparatus of claim 10, wherein the pattern detection sensors are used as registration sensors.

12. The apparatus of claim 9, further comprising:
a light emission time setting part to set and store light emission times of the plurality of laser oscillators to adjust line widths of the forced light emission lines; and
a light emission time adjustment part to adjust light emission times of the plurality of laser oscillators based on the light emission times.

13. The apparatus of claim 12, wherein the light emission times are times in which the line widths of the forced light emission lines become line widths which can be identified by the pattern detection sensors.

14. The apparatus of claim 13, further comprising an operation panel capable of switching and setting the light emission times.

15. An image forming method comprising:
detecting, by two pattern detection sensors, both end positions of forced light emission lines on a transfer belt formed by forced light emission of laser oscillators for yellow, magenta, cyan and black at a time of initialization of a laser exposure device;
calculating shift amounts of a magenta forced light emission line, shift amounts of a cyan forced light emission line, and shift amounts of a black forced light emission line with reference to both end positions of a yellow forced light emission line;
correcting image inclination shifts of magenta, cyan and black based on differences between the shift amounts at both the end positions of the forced light emission lines; and
correcting position shifts of magenta, cyan and black in a sub-scanning direction after the image inclination shifts are corrected.

16. The method of claim 15, wherein the image inclination shifts are corrected by driving tilt mirrors.

17. The method of claim 16, wherein the position shifts in the sub-scanning direction are corrected by adjusting scanning timings of the laser oscillators for magenta, cyan and black.

18. The method of claim 17, further comprising:
calculating arithmetic averages of the shift amounts of both the end positions of the forced light emission lines for magenta, cyan and black;
setting a registration flag when one of the arithmetic average values of the shift amounts is outside a specified value; and
executing registration based on the registration flag.

19. The method of claim 18, further comprising:
adjusting light emission times of the laser oscillators for yellow, magenta, cyan and black; and
continuing the light emission of the laser oscillator until the forced light emission lines come to have line widths which can be identified by the pattern detection sensors.

20. The method of claim 19, further comprising switching the light emission times based on light emission time setting information set by an operation panel.
